(19) United States
(12) Patent Application Publication
(10) Pub. No.: US 2005/0135611 A1
(43) Pub. Date: Jun. 23, 2005

(54) Method and system for wireless digital communication

(76) Inventor: Robert Hardacker, Escondido, CA (US)

Correspondence Address: ROGITZ & ASSOCIATES, 750 B STREET, SUITE 3120, SAN DIEGO, CA, 92101, US

(21) Appl. No.: 11/036,932

(22) Filed: Jan. 14, 2005

Related U.S. Application Data
(63) Continuation-in-part of application No. 10/666,724, filed on Sep. 19, 2003.
(63) Continuation-in-part of application No. 10/937,162, filed on Sep. 9, 2004.

(51) Int. Cl. H04K 1/00

(52) U.S. Cl. 380/33; 380/270

(57) ABSTRACT

Data such as high definition (HD) video may be sent from a transmitter such as a laptop computer to a receiver such as a video projector using a 60 GHz (and, hence, inherently directional, short range, and thus secure) forward channel wireless link. Encryption information such as encryption keys are also exchanged over the forward channel link. The encryption information is used to encrypt control signals that can be exchanged over a reverse channel link that may operate at a frequency of 2.4 GHz.

### RELATED APPLICATIONS

This is a continuation-in-part of and claims priority from U.S. patent applications Ser. Nos. 10/666,724 and 10/937,162, incorporated herein by reference.

### FIELD OF THE INVENTION

The present invention relates generally to wireless digital communication systems.

### BACKGROUND

The wireless spectrum between 57 GHz and 64 GHz (hereinafter “60 GHz band”) is unlicensed by the U.S. Federal Communications Commission, to give organizations the opportunity, unfettered by excessive regulations, to use this spectrum for implementing wireless local area networks (LANs). The wireless LANs, in turn, can be used in a large number of applications owing to the characteristics of the 60 GHz spectrum, which include short range, high directivity (and, hence, inherent security), and large data bandwidth.

Originally used for covert satellite-to-satellite communications (the Earth's atmosphere severely attenuates signals with frequencies around 60 GHz), current applications for 60 GHz wireless LANs include communications between a bank customer and an automatic teller machine, “last-mile” extension of wider area networks, and many other applications in which wireless, high bandwidth, yet localized and inherently secure data communication is desired. As an example, in the first of the above-referenced U.S. patent applications, a system is disclosed for sending high definition (HD) video in High Definition Multimedia Interface (HDMI) format from a laptop computer on a table in a room to a video projector mounted on the ceiling using a high bandwidth 60 GHz link. At this frequency the signal is so short range and directional that the video may be transmitted in an uncompressed form such that so much data is transmitted each second that bootlegging the content is essentially untenable.

Regardless of the particular application, the present invention makes the following critical observations. In some applications, a transmitter and receiver might communicate certain high bandwidth data such as multimedia on a 60 GHz forward channel and certain low bandwidth data such as control data on a lower frequency reverse channel. As recognized herein, while the forward channel is inherently secure owing to the high frequency and directionality, the reverse channel, at a lower frequency and not amenable to as precisely controlled directionality, is not as inherently secure.

### SUMMARY OF THE INVENTION

A system includes a transmitter of multimedia data and a receiver of multimedia data. The transmitter wirelessly transmits the multimedia data on a forward channel link in the sixty GigaHertz (60 GHz) band. Also, the transmitter and receiver exchange encryption information on the forward channel link. In accordance with present principles, the encryption information is used to protect data transmitted between the transmitter and receiver on a reverse channel link, which may be at approximately 2.4 GHz.

In one implementation the encryption information includes an encryption key, and the transmitter and/or receiver uses the key to encrypt control information prior to sending the control information over the reverse channel link. Alternatively, the encryption information can be established by a unique identifier that is combined with control information prior to sending the control information over the reverse channel link. In specific embodiments the unique identifier may be “OR'ed” with the control information prior to sending the control information over the reverse channel link.

In another aspect, a method for transmitting data includes establishing a forward channel link and a reverse channel between a wireless transmitter and a wireless receiver. The forward channel link is inherently more directional and shorter range than the reverse channel link. The method also includes communicating encryption information over the forward channel link. Data may be altered using the encryption information and then communicated over the reverse channel link.

In yet another aspect, a computer includes means for communicating unencrypted multimedia data and encryption information using a wireless forward channel link in the 60 GHz band, as well as means for altering control information using the encryption information. Means are provided for communicating altered control information over a reverse channel link that is not in the 60 GHz band. The altered control information cannot be easily used by a recipient without access to the encryption information.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present system;

FIG. 2 is a block diagram of the detailed architecture;

FIG. 3 is a flow chart of one logic scheme that may be implemented by any of the processors disclosed herein; and

FIG. 4 is a flow chart of another logic scheme that may be implemented by a processor in accordance with he present invention.

### DETAILED DESCRIPTION OF THE PREFERRED EMBODIMENT

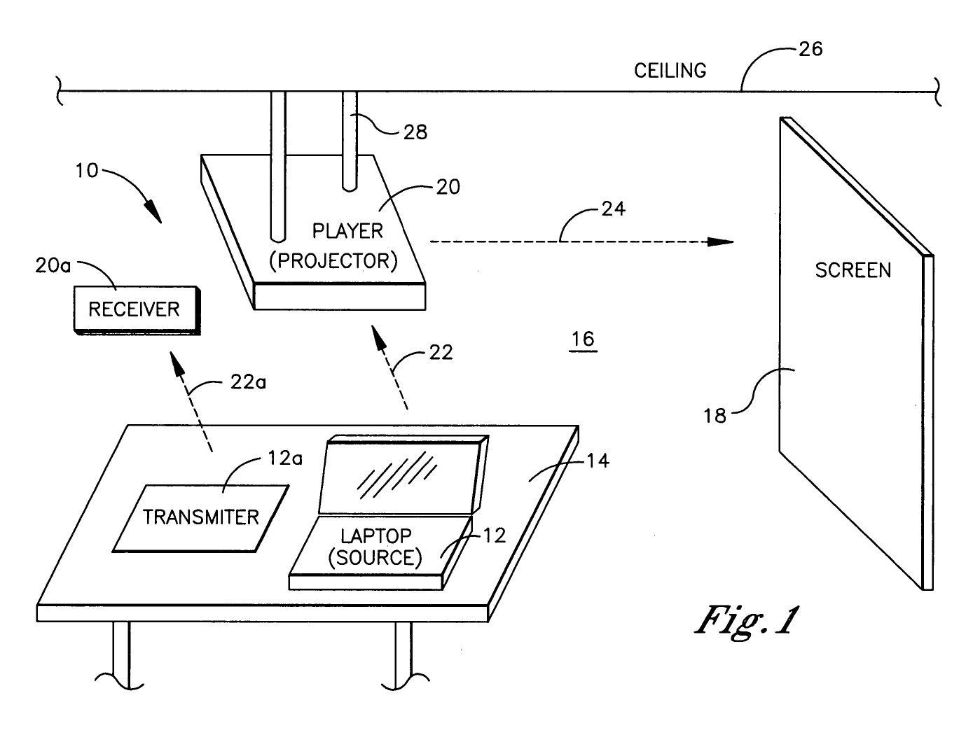

Referring initially to FIG. 1, a system is shown, generally designated 10, which includes a source 12 of multimedia data, and in particular HD video. The source 12 may be a laptop computer or other multimedia computer or server that, for instance, a user may place on a table 14 in a room 16 to display the multimedia on a screen or wall 18 using, e.g., a multimedia player 20 such as a video projector that receives the multimedia over a wireless forward channel link 22, for displaying the multimedia on the screen or wall 18 as indicated by the arrow 24. Additional sources and/or receivers can be present in the system 10. For example, a second source 12a can communicate with a second receiver 20a over a forward channel link 22a. Each source may communicate with its receiver over a reverse channel link as well. While multimedia data is envisioned as being communicated over a forward channel link, other types of data are contemplated herein.

When the forward channel links are in the 60 GHz band, they are inherently secure because their high frequency forecloses transmission through walls and enables very precise control of the directionality of the transmitted beams. However, the lower frequency reverse channel links may not be as inherently directional, short range, and, hence, as inherently secure, and so the invention set forth below is provided.

In the non-limiting embodiment shown, the player 20 advantageously may be mounted on a ceiling 26 of the room 16 by, e.g., one or more mounting brackets or struts 28, either in front of or behind the screen 18 depending on the type of player. Owing to the presently envisioned wireless link, no wiring except for power need be installed in the ceiling 26, and the player 20 need not include an MPEG or other video decompression module.

Alternatively, the multimedia player may include a cathode ray tube (CRT), liquid crystal display (LCD), plasma display panel (PDP), or TFT for displaying the multimedia data. The source of multimedia data may be a set-top box like device capable of decoding compressed multimedia content as received from a satellite, cable, terrestrial broadcast, internet streaming, or other source. The data communication described herein may use digital visual interface (DVI) protocols.

In accordance with present principles, the link 22 is a forward channel link that carries a frequency which is sufficiently high that the signal on the link substantially cannot be received outside the room. Also, multimedia may be transmitted in an uncompressed form on the link 22 such that so much data is transmitted each second that bootlegging the content is essentially untenable, although some data compression less preferably may be implemented. The data may also be transmitted in compressed form if desired. As discussed further below, the link 22 preferably operates at a fixed (unvarying, single-only) frequency of approximately sixty GigaHertz (60 GHz), and more preferably in the range of 57 GHz-64 GHz, and the link 22 has a data rate, preferably fixed, of up to two Giga bits per second (2.0 Gbps). Various modulation schemes may increase the data rate, e.g., when DQPSK is used the data rate may be 2.2 Gbps, and the link may have a data rate of approximately 2.5 Gbps. The link may have a fixed bandwidth of up to seven GigaHertz (7 GHz). Error correction appropriate for wireless transmission (e.g., Reed-Solomon encoding) as well as appropriate re-multiplexing (e.g., by re-multiplexing twenty four lines of video and appropriate control signals into two in the case of QPSK modulation) may be implemented in some applications accordance with wireless transmission principles known in the art.

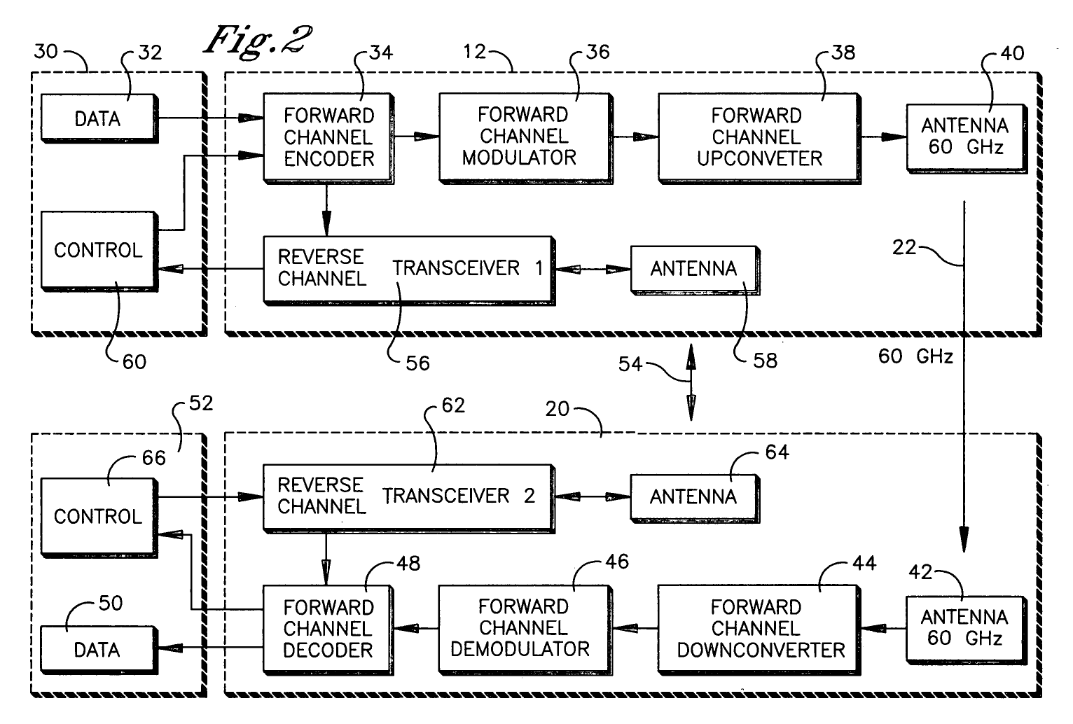

FIG. 2 shows further details of the system 10. The non-limiting source 12 includes a processor 30 that accesses a data storage device 32 such as a hard disk drive, CD, or DVD to send multimedia data to a forward channel encoder 34 for encoding in accordance with principles known in the art. The encoded data is modulated at approximately 60 GHz by a 60 GHz forward channel modulator 36 and upconverted by an upconverter 38 for transmission over the link 22 at about 60 GHz through a first source antenna 40 that is configured as appropriate as a 60 GHz antenna. Using the above-described wide channel and a simpler modulation scheme such as but not limited to DQPSK, QPSK, BPSK or 8-PSK, a high data rate yet simple system can be achieved. For example, when DQPSK is used, a data rate of twice the symbol rate can be achieved. For 8-PSK a data rate of 3.3 Gbps may be achieved. If desired, a copy protect system such as high definition copy protection (HDCP) can be used with the multimedia content in accordance with HD principles known in the art.

The multimedia signal is received at a first player antenna 42 (configured for 60 GHz operation) on the player 20. In accordance with principles known in the art, the signal is downconverted at a forward channel downconverter 44 and demodulated from 60 GHz at a forward channel 60 GHz demodulator 46, and then decoded at a forward channel decoder 48 that can undertake error correction and multiplexing functions. The decoded signal may be stored in a data storage device 50 of a processor 52 of the player 20. It will be recognized by those skilled in the art that the components 34-38 of the player 12 establish at least a portion of a wireless transmitter and the components 44-48 of the player 20 establish at least a portion of a wireless receiver.

In addition to carrying the multimedia data proper, the forward channel link 22 may carry encoding information such as encoding keys and/or a unique identifier that may be multiplexed within the multimedia data, so that the decoder 48 can decode the streams and obtain the encoding information. The encoding information may be used as set forth further below. If desired, the forward channel link 22 can be a full duplex link, so that the player 20 can communicate information back to the source 12. For example, the player 20 may communicate capabilities and if necessary its own encryption information to the source 12. Or, the player 20 can communicate reception conditions so that the transmission power of the source 12 and/or directivity of the first source antenna 40 can be established to minimize power while maximizing reception. Automatic gain control and automatic antenna beam control adjustment thereby can be effected by the processor 30 of the source 12.

Additionally, a reverse link 54 such as but not limited to Bluetooth, 802.11, 802.15, infrared, PLC, HPNA, or any other suitable link such as a wireless link operating at 2.4 GHz is provided.

It is to be understood that although 60 GHz is not required for both the forward and reverse link, since the data rate requirement particularly for the reverse link does not merit the expense, both a half-duplex and full-duplex 60 GHz transceiver are envisioned. Thus, a full duplex 60 GHz version can be used for establishing both the forward and reverse links, and the forward channel can be established by one 60 GHz sub-band (e.g., 60-61 GHz) and the reverse channel can be established by another 60 GHz sub-band, e.g., 61-62 GHz. In any case, encryption can be used particularly when private or confidential data is to be exchanged.

In one non-limiting implementation the source 12 includes a reverse channel transceiver 56 that sends and receives control signals over a second source antenna 58 and that stores/processes the control signals in a control signal module 60. The module 60 may be a software-implemented module accessed by the processor 30 of the source 12 as shown. Similarly, because a reverse channel link is used, the player 20 includes a control signal transceiver 62 that sends and receives signals over a second player antenna 64 and that stores/processes the information in a control signal module 66. The module 66 may be a software-implemented module accessed by the processor 52 of the player 20 as shown. The control signals may be, e.g., audio and video display function information including trick play features, communication capabilities, reception conditions so that the transmission power of the source 12 and/or directivity of the first source antenna 40 can be established to minimize power while maximizing reception, and encryption information as set forth further below.

In the second of the above-referenced patent applications, it was recognized that when the reverse links between transmitter-receiver pairs are 2.4 GHz radio links, they might interfere with each other and/or communicate with the wrong transmitter. Accordingly, the second of the above-referenced patent applications proposes a receiver (or the associated source) sending an identifier that is unique to the pair to the source (or associated receiver) on the 60 GHz forward channel, with subsequent communications from the source (or associated receiver) being ignored unless the unique identifier was echoed back as part of the communication. As recognized herein, however, while echoing back the unique identifier in the clear effectively resolves miscommunication, the reverse channel 2.4 GHz link remains inherently less secure than the 60 GHz forward channel link.

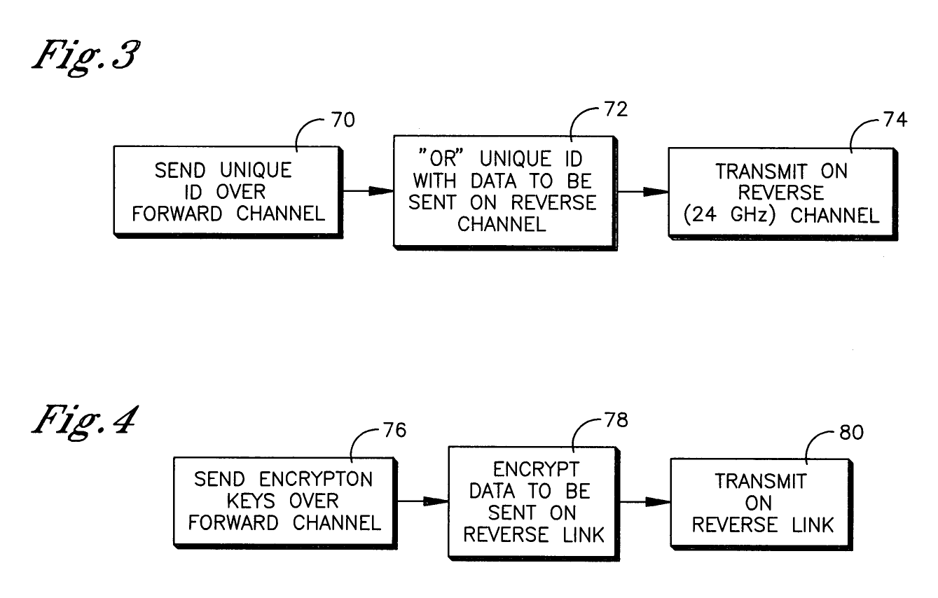

Accordingly, turning to FIG. 3, in one implementation the unique identifier mentioned above and described in the second of the above-referenced patent applications is sent over the forward (60 GHz) channel link 22a from, e.g., the transmitter 12a to the receiver 20a, it being understood that the receiver 20a alternatively could generate and send the unique identifier to the transmitter 12a. Moving to block 72, when one of the receiver or transmitter has data such as control signals to communicate on the reverse channel (e.g., 2.4 GHz) link, the data is “OR'ed” (using, e.g., a wired “OR”) or otherwise combined with the unique identifier, and then transmitted at block 74. The recipient executes the reverse of the combination performed at block 72 to render the information in usable form.

Instead of using an “OR” or other function of the unique identifier, FIG. 4 shows that one or more encryption keys for, e.g., Data Encryption Standard (DES) or Advanced Encryption Standard (AES) encryption can be sent at block 76 over the forward (60 GHz) channel link 22a from, e.g., the transmitter 12a to the receiver 20a, it being understood that the receiver 20a alternatively could generate and send the keys to the transmitter 12a. Moving to block 78, when one of the receiver or transmitter has data such as control signals to communicate on the reverse channel (e.g., 2.4 GHz) link, the data is encrypted using the keys, and then transmitted at block 80. The recipient decrypts the information using the keys.

While the particular METHOD AND SYSTEM FOR WIRELESS DIGITAL COMMUNICATION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A system, comprising:
a transmitter of multimedia data; and
a receiver of multimedia data, the transmitter wirelessly transmitting the multimedia data on a forward channel link in the sixty GigaHertz (60 GHz) band, the transmitter and receiver exchanging encryption information on the forward channel link, the encryption information being used to protect data transmitted between the transmitter and receiver on a reverse channel link.

2. The system of claim 1, wherein the reverse channel link is at approximately 2.4 GHz.

3. The system of claim 1, wherein the encryption information is at least one encryption key and at least the transmitter or receiver uses the key to encrypt control information prior to sending the control information over the reverse channel link.

4. The system of claim 1, wherein the encryption information is at least one unique identifier and at least the transmitter or receiver combines the unique identifier with control information prior to sending the control information over the reverse channel link.

5. The system of claim 4, wherein the unique identifier is “OR'ed” with the control information prior to sending the control information over the reverse channel link.

6. A method for transmitting data, comprising:
establishing a forward channel link and a reverse channel link between a wireless transmitter and a wireless receiver, the forward channel link being inherently more directional and shorter range than the reverse channel link;
communicating encryption information over the forward channel link;
altering data using the encryption information; and
communicating the data over the reverse channel link.

7. The method of claim 6, wherein the forward channel link is in the 60 GHz band and the reverse channel link has a frequency of between 1 GHz and 10 GHz, inclusive.

8. The method of claim 7, wherein the reverse channel link has a frequency of 2.4 GHz.

9. The method of claim 7, wherein the encryption information is at least one encryption key and at least the transmitter or receiver uses the key to encrypt control information prior to sending the control information over the reverse channel link.

10. The method of claim 7, wherein the encryption information is at least one unique identifier and at least the transmitter or receiver combines the unique identifier with control information prior to sending the control information over the reverse channel link.

11. The method of claim 11, wherein the unique identifier is “OR'ed” with the control information prior to sending the control information over the reverse channel link.

12. A computer comprising:
means for communicating unencrypted multimedia data and encryption information using a wireless forward channel link in the 60 GHz band;
means for altering control information using the encryption information; and
means for communicating altered control information over a reverse channel link not in the 60 GHz band, wherein the altered control information cannot be easily used by a recipient without access to the encryption information.

13. The computer of claim 12, wherein the reverse channel link has a frequency of between 1 GHz and 10 GHz, inclusive.

14. The computer of claim 13, wherein the reverse channel link has a frequency of 2.4 GHz.

15. The computer of claim 12, wherein the encryption information is at least one encryption key and at least the transmitter or receiver uses the key to encrypt control information prior to sending the control information over the reverse channel link.

16. The computer of claim 12, wherein the encryption information is at least one unique identifier and the computer combines the unique identifier with control information prior to sending the control information over the reverse channel link.

17. The computer of claim 16, wherein the unique identifier is “OR'ed” with the control information prior to sending the control information over the reverse channel link.
